(19) United States
(12) Patent Application Publication
(10) Pub. No.: US 2005/0085281 A1
(43) Pub. Date: Apr. 21, 2005

(54) Infinite speed space communications using information globes

(76) Inventor: Robert W. Beckwith, Clearwater, FL (US)

Correspondence Address: Leo J. Aubel, 111 Rivershire Lane, Lincolnshire, IL, 60069, US

(21) Appl. No.: 11/007,683

(22) Filed: Dec. 8, 2004

Related U.S. Application Data
(63) Continuation-in-part of application No. 09/858,938, filed on May 16, 2001.
Application No. 09/858,938 is a continuation-in-part of application No. 09/504,662, filed on Feb. 14, 2000, now abandoned.
Application No. 09/504,662 is a continuation-in-part of application No. 09/059,738, filed on Apr. 15, 1998, now abandoned.
(60) Provisional application No. 60/043,977, filed on Apr. 23, 1997.

(51) Int. Cl. H04B 1/00; H04H 1/00; H04M 1/00; H01S 4/00

(52) U.S. Cl. 455/899

(57) ABSTRACT

Apparatus and methods for studying the use of divided space globes, containing electromagnetic fields of digital information, to travel through universal space at nearly infinite speeds.

This is a third continuation in part of a second continuation in part filed May 16, 2001, application Ser. No. 09/858,938, which was a first continuation in part, filed Feb. 14, 2000, application Ser. No. 09/504,662 of patent application Ser. No. 09/059,738 filed on Apr. 15, 1998 and claims the priority date of provisional patent application Ser. No. 60/043,977 filed on Apr. 23, 1997.

In this document “I” and “my” will be used to refer to myself, Robert W. Beckwith, as both the inventor and writer of this patent document.

### BACKGROUND OF THE INVENTION

Strong rotating magnetic fields are used to enclose stealth ships and airplanes in their own divided space, free from universal space. Once the separation is made, teleportation to another location can be made in essentially zero time. Things, living or not, suffer no changes whatsoever so long as they contain no iron or other magnetic material that can pick up destructive energy from the large magnetic fields used to accomplish the teleportation.

### SUMMARY OF INVENTION

Universal space is defined by the universe in which we live. Globes of gas are separated from universal space by rotating currents among four or more ring conductors positioned equally around a globe of air or other gas. A three phase electromagnetic field is created within the globes using three currents obtained from a radio frequency (rf) source. These currents are spaced on three antennae with a 1200 time spacing between signals on the three antennae. This creates a rotating rf signal having a positive-phase-sequence force in the direction where the four ring conductors join. After one or so turns of the currents in the ring conductors the globe forms a divided space propelled by the positive-phase-sequence force of the rf signal at nearly infinite speed in a selected direction.

Readily available 900 mHz transmitting and receiving devices are preferred giving a theoretical top data rate of 900 mbs using frequency shift keyed (fsk) coding. This assumes one turn of the currents in the ring conductors per bit. Communications information, such as video signals, are coded as frequency shifts in the rf energy from one globe to the next.

Receivers consist of a focusing reflector having a bed of quarter wavelength antennae excited by receipt of globes which puncture the globes and thus receive the 900 mHz signals. These signals are reflected to common 900 mHz receivers providing serial binary outputs. The reflector broadens the angle within which the sender must track the direction in which globes are sent.

### BRIEF DESCRIPTION OF THE DRAWINGS

FIGS. 1a to f illustrates apparatus for sending divided space globes.

FIG. 2 illustrates apparatus for receiving divided space globes.

FIG. 3 shows a divided globe of gas with no molecular ties to molecules of universal space.

### REFERENCES

The following six expired patents are in my name:
FREQUENCY RESPONSE CIRCUITS U.S. Pat. No. 2,461,956 Feb. 15, 1949
FREQUENCY SHIFT OSCILLATOR CIRCUIT U.S. Pat. No. 2,531,103 Nov. 21, 1950
FREQUENCY RESPONSE CIRCUITS U.S. Pat. No. 2,712,600 Jul. 5, 1955
COMMUNICATION SYSTEM HAVING KEYED CARRIER TO FREQUENCY SHIFT CONVERSION U.S. Pat. No. 2,802,936 Aug. 13, 1957
METHOD AND APPARATUS FOR TRANSMISSION OF INTELLIGENCE U.S. Pat. No. 2,871,463 Jan. 27, 1959

### DESCRIPTION OF THE PREFERRED EMBODIMENTS

This inventive apparatus is intended for use in determining whether communications at nearly infinite speed is possible by sending globes of divided space from a first location to a second location. If found possible, the apparatus is further intended for use in optimizing said apparatus.

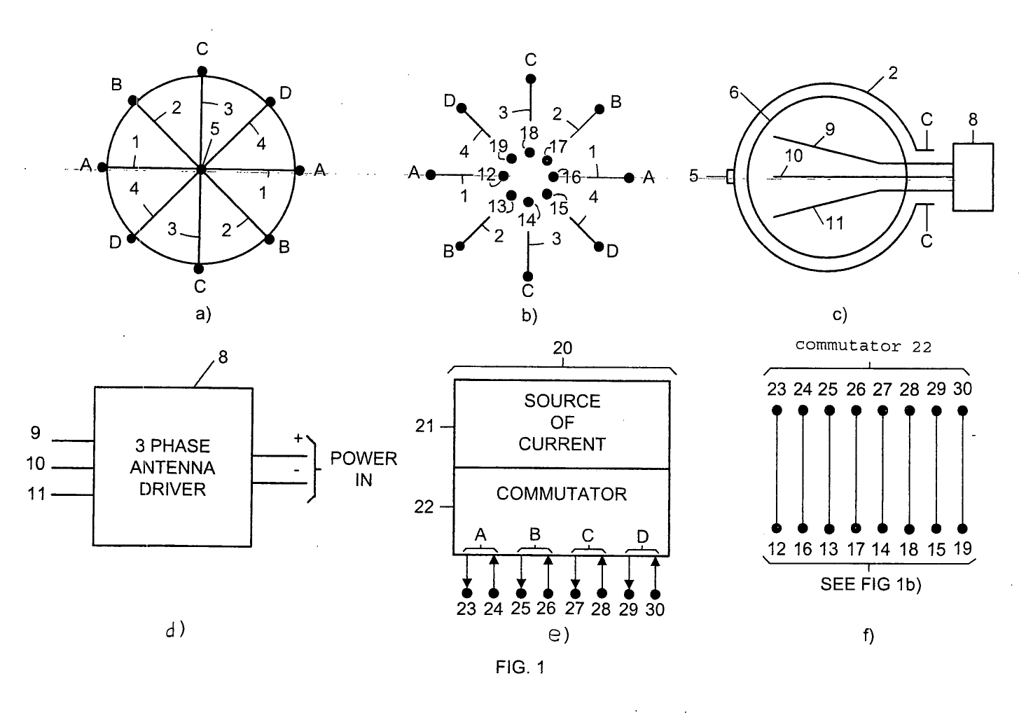

FIG. 1a shows a front view of a global sending device with point 5 being a common connection point of four nearly complete circles 1, 2, 3, and 4. of corresponding conductors A, B, C, and D.

FIG. 1b shows the back end of said global sending device showing circular conductor A having current input/output terminals 12 and 16 respectively, circular conductor B having input/output terminals 13 and 17 respectively, circular conductor C having input/output terminals 14 and 18 respectively and circular conductor D having input/output terminals 15 and 19 respectively.

FIG. 1e shows device 20 having a source of current 21 fed to commutator 22. Commutator 22 has outputs A, B, C and D. Output A has a source output 23 and sink input 24. Output B has a source output 25 and sink input 26. Output C has a source output 27 and sink input 28. Output D has a source output 29 and sink input 30.

FIG. 1f shows commutator output 23 connected to circular conductor A12, commutator input 24 connected to circular conductor A16, commutator output 25 connected to circular conductor B13, commutator input 26 connected to circular conductor B17, commutator output 27 connected to circular conductor C14, commutator input 28 connected to circular conductor C18, commutator output 29 connected to circular conductor D15, and commutator input 30 connected to circular conductor D19.

The rotation of currents within the circular conductors creates a rotating magnetic field around a sharply divided global path 6 capable of reconnecting molecule to molecule bonding forces and leaving no such bonding forces between any molecules in the globe 6 and a molecule in universal space. Thus there is no force between the divided space globe 6 and universal space.

FIG. 1c shows three phase antenna driver 8. Preferably this consists of a 900 mHz source together with delay lines as required to drive antennae 9, 10 and 11 with 120° time spacing at 900 mHz.

Three phase antennae 9, 10 and 11 produce a rotating electromagnetic field, preferably at about 900 mHz, with a positive sequence force directing a separated globe in a forward direction.

The frequency of the rf energy contained in alternate globes is keyed back and forth as required for sending data in well known fsk format. Please see reference patents listed above by the present inventer which first established principles and methods of generating fsk signals.

FIG. 1c shows a globe 6 of air or any other gas of convenience about to be teleported from said first point to said second point in zero time. Only conductor circle C2 is shown in FIG. 1c.

The frequency of commutation is determined experimentally as is the magnitude of current commutated. Said sending device will be constructed with more than four conducting rings and commutated with corresponding additional input/output current sources in order to determine an optimum number of conducting rings.

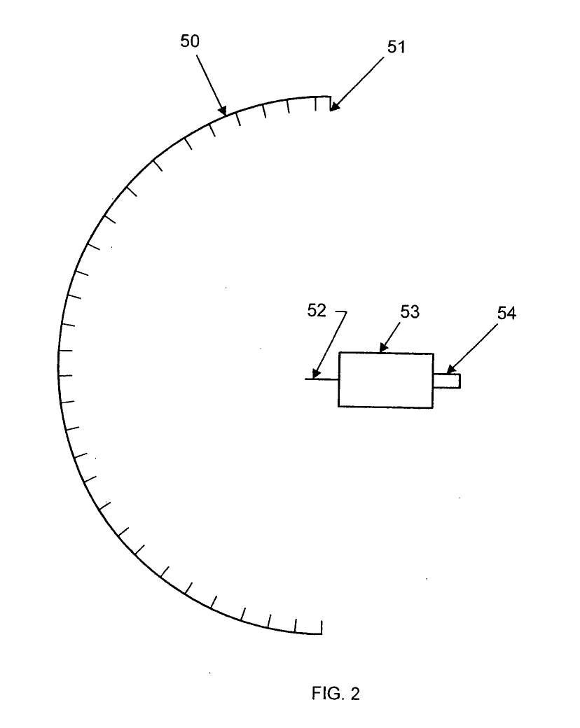

FIG. 2 shows a parabolic receiving dish 50 having a number of quarter wave antennae 51. When struck by some globe the antennae 51 will be excited by the electromotive energy within the globe and the received excitation, serial in time as sent by the sending device, is focused on receiving antenna 52 of receiver 53. The received signals are fed out in serial form from receiver 52 coaxial output 54 for use by conventional fsk apparatus.

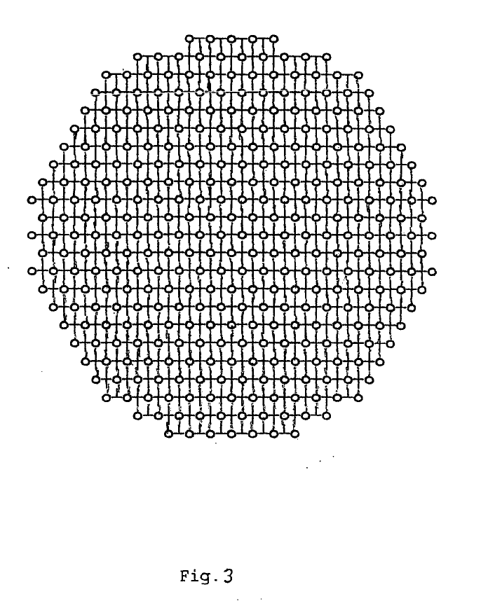

Globe 6 is shown in more detail in FIG. 3 where gas molecules are indicated by circles. The gravity force lines between atoms of gas are shown all to be connected in forming the ball with no gravity force connections to molecules in universal space. Thus the globe is free to teleport to any other location, relative to universal space, in zero time.

1. A method of communicating at nearly infinite speed, said method consisting of the steps of:
a) surrounding globes of gas with conducting rings,
b) producing rotating magnetic fields by passing electric currents through said conducting rings,
c) commutating said electric currents causing currents in alternating directions to move around said globe, and
d) searching for combinations of currents and number of said conducting rings that causes globes of gas to teleport out of said conducting rings at nearly infinite speed.

2. A method as in claim 1 further including the steps of:
a) providing three phase antennae within global space surrounded by said conducting rings, and
b) including rf energy within said teleported globes by driving said three antennae with signals space 120° in time from each other.

3. A method as in claim 2 further including the steps of:
a) shifting the frequency of succeeding included rf energy so as to send fsk coded information,
b) providing parabolic receiving dish for said communications,
c) providing quarter wave receiving antennae for said parabolic dish for said teleported globes to strike releasing any rf energy within said globes thus exciting said antennae,
d) providing antennae located for receiving rf energy reflected to the focal point of said parabolic dish by any said receiving antennae,
e) receiving said fsk coded information, and
f) providing outputs useable by conventional fsk apparatus.
